(19) United States
(12) Patent Application Publication
(10) Pub. No.: US 2005/0056487 A1
(43) Pub. Date: Mar. 17, 2005

(54) Combination tree stand and recliner seat

(76) Inventor: Eduardo G. Concepcion, Miami, FL (US)

Correspondence Address: COCHRAN FREUND & YOUNG LLC, 2026 CARIBOU DR, SUITE 200, FORT COLLINS, CO, 80525, US

(21) Appl. No.: 10/896,638

(22) Filed: Jul. 21, 2004

Related U.S. Application Data
(60) Provisional application No. 60/488,888, filed on Jul. 21, 2003.

(51) Int. Cl. E06C 7/16

(52) U.S. Cl. 182/136

(57) ABSTRACT

Disclosed is a method and device for a tree or tripod stand that has a moveable recliner sling seat for entry and exiting. The tree stand embodiment has the capability of being deployed as a fixed stand (permanently on the tree) or as a ladder stand with the “ladder option” installed, thereby creating two stands in one.

### CROSS REFERENCE TO RELATED APPLICATIONS

This application is based upon and claims the benefit of U.S. provisional application No. 60/488,888, entitled “Combination Tree Stand and Recliner Seat”, filed Jul. 21, 2003, the entire disclosure of which is herein specifically incorporated by reference for all that it discloses and teaches.

### BACKGROUND OF THE INVENTION

a. Field of the Invention

The present invention relates generally to climbing tree stands, and more specifically to apparatus for support of a person on a reclining seat suspended from the trunk of a tree and used for viewing or hunting wildlife from an elevated position. In this art, “tree stand” or “stand” is a generic term that includes devices or platforms configured for standing, for sitting, or for laying, so use of “tree stand”, or “stand” herein is broad enough to cover apparatus designed to accommodate any or all of those uses.

b. Description of the Background

Hunters, photographers, and wildlife enthusiasts have long enjoyed using raised platforms to gain greater access to wildlife and game. Usually these platforms have small seats that attach to a tree trunk or other stable elevation structure and often include a platform on which a person may stand or sit. These stands are typically entered (and exited) utilizing a stationary ladder or screwed-in tree steps installed “adjacent” the platform. With such stands or seats, a user must maneuver himself/herself from the steps into the stand or seat, which is often positioned high above the ground. This maneuver can be a somewhat dangerous maneuver if it is not performed carefully and with the required agility and balance. A hunter, for instance, may often be required to sit for long hours waiting for game to pass by, resulting in an uncomfortable and enduring experience which can reduce the overall enjoyment of the hunt. Since the vast majority of hunters do not hunt for necessity, they are often only willing to stay in their uncomfortable seats for a short period of time.

Tree stands with a recliner type sling seat have been previously contemplated by the inventor in U.S. Pat. No. 5,954,158, which is hereby incorporated by reference herein for all it teaches and discloses. Whereas the stand in that patent is a portable, self-climbing tree stand, it is limited in applications and can only be deployed on smooth trees, where there are no upper branches obstructing the upward climb.

### SUMMARY OF THE INVENTION

The present invention overcomes some of the disadvantages and limitations of the prior art by providing a tree or tripod stand that has a moveable recliner sling seat to facilitate entry and exiting. The tree stand embodiment has the capability of being deployed as a fixed stand (temporarily or permanently on the tree), as a ladder stand with the “ladder option” installed, or on a free-standing tripod.

An embodiment of the present invention may therefore comprise a viewing and hunting stand for attachment to a substantially rigid structure to support a person in an elevated position comprising: a detachable support including a frame for supporting the person; an attachment bracket with connectors for fixedly attaching the bracket to the substantially rigid structure; and a receiver on the attachment bracket to removably attach the detachable support to the recliner bracket.

An embodiment of the present invention may also comprise a method for creating an elevated viewing and hunting stand comprising the steps of: attaching a recliner bracket to a substantially rigid structure, the recliner bracket having a receiver for releasably attaching an upper portion of a detachable recliner assembly to the recliner bracket such that the detachable recliner assembly will pivot at the point of the receiver while supporting the weight of the detachable recliner assembly and the person, a horizontal support member that connects the recliner bracket below the point of the receiver to the detachable recliner assembly, thereby supporting a lower portion of the detachable recliner assembly away from the recliner bracket at an angle; attaching the detachable recliner assembly having a frame for supporting the person, a sling of flexible material that is supported on opposing ends by a pair of rigid cross members that are laterally supported by the frame thereby forming a recliner seat for the person to the recliner bracket.

An embodiment of the present invention may also comprise a platform apparatus for supporting a person above the ground, including a frame adapted for attachment to substantially rigid structure and a detachable support connected to and supported by the frame in a use position for supporting the person in a seat space above the ground comprising: means for allowing the seat to be moved with respect to the frame enough for the person to pass through at least a portion of the seat space.

The disclosed embodiments provide a tree stand for hunting or viewing game that can function either as a fixed tree stand, an adjustable ladder stand, or a freestanding tripod stand. The disclosed embodiments offer the advantage of providing a tree stand with a recliner seat which allows easier, safer and more convenient entry and exit for a person transitioning between the ladder stand and the recliner seat. The disclosed stands utilize a removable seating frame which can be easily transferred between a plurality of locations and are adaptable for use with tree steps, pole climbing spikes, a tree ladder, a tripod, and other conventional devices for climbing above the ground. The embodiments combine the features and advantages of a ladder stand, a fixed-position seat stand, as well as the recliner-type sling seat, resulting in a versatile, comfortable tree stand, which is safer to use than conventional designs.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

In the drawings:

FIG. 1 is an isometric view of an embodiment of a tree stand with a recliner seat of the present invention mounted on a tree with a ladder connected to the tree stand;

FIG. 2 is an isometric view of an embodiment of a recliner seat of a tree stand with a recliner seat with the top portion of the sling seat shown detached from the frame to accommodate moving the sling seat aside according to this invention;

FIG. 3 is an isometric view of an embodiment of a bracket assembly for the tree stand of this invention mounted on the tree before the seat assembly (not shown in FIG. 2) is connected to the bracket assembly;

FIG. 4 is an isometric view of an embodiment of the bracket assembly of the tree stand with a ladder attached to it, but shown without the seat assembly attached to the bracket;

FIG. 5 is an isometric view of the seat assembly and the ladder connected to the bracket assembly and illustrated with a portion of the sling seat cut away to reveal the components under the sling seat;

FIG. 6 is a perspective view of the seat assembly and bracket assembly mounted on a tree in a position ready for use;

FIG. 7 is an isometric view of an embodiment of the bracket assembly of the tree stand installed onto the tree in combination with tree steps attached to the tree;

FIG. 8 is an isometric view of an embodiment of the tree stand mounted on a tripod for use as a free standing elevated stand.

### DETAILED DESCRIPTION OF THE INVENTION

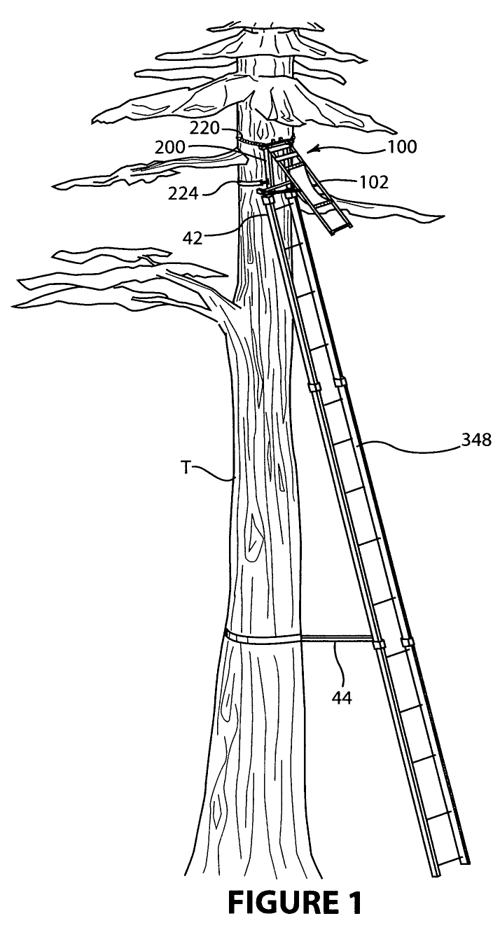

An example tree stand 100 with a reclining seat assembly 102 according to this invention is shown in FIG. 1 mounted on a tree T with a ladder 348 connected to the tree stand 100, as will be described in more detail below. The seat assembly 102 is preferably attached in a releasable manner to a tree bracket assembly 200, after the bracket assembly 200 is mounted in a secure manner on the tree T. Such a secure mounting of the bracket assembly 200 to the tree T can be accomplished in any of a number of different ways, such as, for example, the chain 220 and strap 224 shown in FIG. 1. The ladder 348 is one of several options for a user to climb from the ground to the tree stand 100. When the ladder 348 is used, its upper end 42 is preferably connected to the bracket assembly 200, and one or more optional ladder braces 44 extending between the ladder 40 and the tree T can be used to further stabilize the ladder 348.

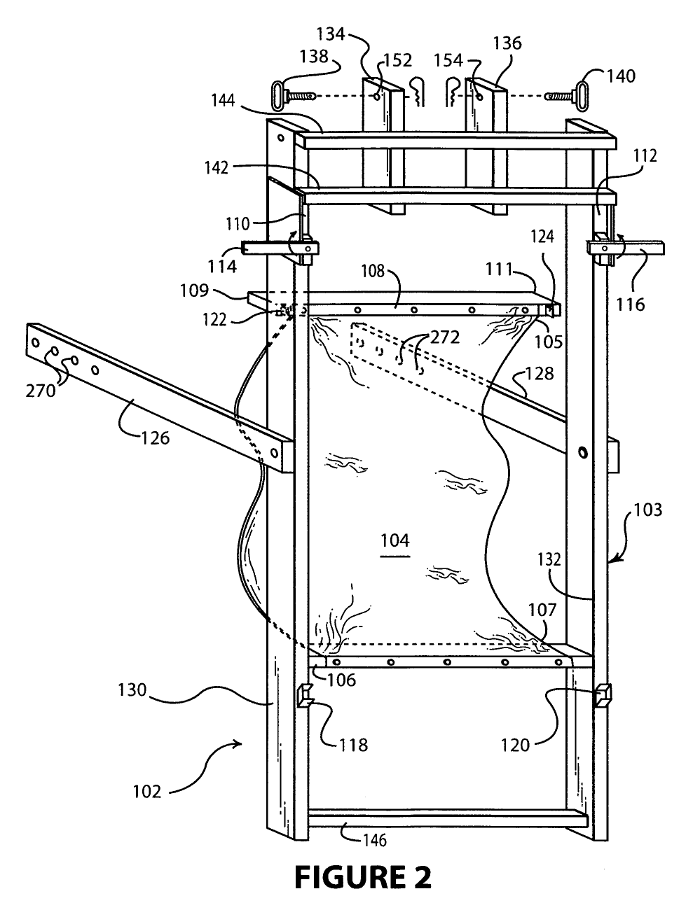

The seat assembly 102 of the tree stand 100 is shown in more detail in FIG. 2 with the top portion of the sling seat 104 shown temporarily detached from the seat assembly frame 103 to allow a user to climb between the vertical support members 130, 132 to get onto the top of the seat assembly 102 or to go from the top of the seat assembly 102 back to the ladder 348. As illustrated in FIG. 1, the sling seat 104, which can be made, for example, of a flexible fabric, polymer or any other material that is strong enough to support a user, is attachable at its upper end 105 to a moveable cross member 108 and extends across the space between the vertical support members 130, 132 to form a sling-type seat with its lower end 107 attached to a rigid cross member 106 of the frame 103. The lateral ends 109, 111 of the moveable cross member 108 are sized and shaped for resting in a pair of frame pockets 110 and 112, which support the top end 105 of the sling seat 104 when the sling seat 104 is positioned to support a person. The ends 109, 111 of the cross member 108 can be releasably secured in the pockets 110, 112 with a pair of locks 114 and 116 engaging until they make contact with stops 122 and 124 to prevent unwanted disengagement. Of course, any other convenient locking or fastening devices, such as bolts, pins, or other instrumentalities known to persons skilled in the art can also be used to secure the cross member 108 in place. Alternatively, when the cross member 108 is removed from the pockets 110, 112 to move the sling seat 104 aside so that a user can climb between the vertical support members 130, 132, as described above, the cross member 108 can be placed into a pair of lower retainer pockets 118 and 120 to hold the sling seat 104 in a temporary non-use position. In this non-use position, the seat 104 material is not suspended across the space bounded by the vertical support members 130, 132 and by the upper and lower cross members 142, 106, thereby allowing room for ingress onto, or egress from, the stand from below. This feature is very important, since, by entering the stand through that space from below the seat assembly 102, the user does not have to jump into the stand from an adjacent ladder or tree steps or have to climb around the outside of the seat assembly frame 103 to get on top of it.

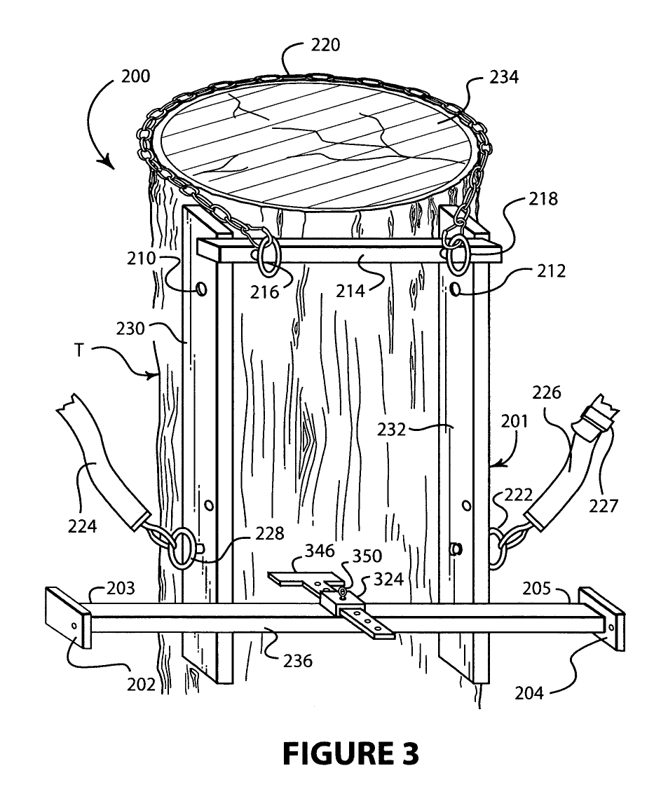

The frame 103 of the seat assembly 102 has two longitudinal support members 134 and 136 extending upwardly from cross members 142, 144 with respective holes 152 and 154 near the upper end of each support 134, 136. These support members 134 and 136 are used to attach the seat assembly 102 to the tree bracket assembly 200 (FIG. 3) by aligning the holes 152, 154 to holes 210 and 212 of the recliner bracket 200 using hitch pins 138 and 140, as will be described in more detail below. This connection provides a fixed mount for the top of the seat assembly 102 to the tree bracket 200, while allowing the support members 134 and 136 to pivot about the connection point created with the hitch pins 138 and 140 until the horizontal support members 126, 128 are connected to the tree bracket assembly 200, as will also be described below. The frame 103 may also contain hinge points at or near a midpoint to allow the seat assembly to fold so as to be carried in a more easy fashion by a user.

The tree bracket assembly 200, which holds the seat assembly 102 on a tree T is best seen in FIG. 3. As illustrated in FIG. 3, the bracket assembly 200 is comprised of two vertical side braces 230 and 232 that are rigidly fixed in a substantially parallel manner to one another by two substantially parallel cross members 214, 236. The upper cross member 214 joins the upper portion of the vertical side braces 230 and 232, and the lower cross member 236 joins the lower portion of the vertical side braces 230 and 232 to create a rigid rectangular frame structure 201.

The bracket assembly 200 can be mounted on the tree T in any secure manner, such as, for example, with a chain 220 and a strap 224. A pair of eyebolts 216 and 218 at either end of cross member 214 can be used to connect the ends of the chain 224 to the bracket assembly 200. One end of a chain 220 is connected securely to a first eyebolt 216, and the chain 220 extends tightly around the tree trunk 234 with the other end of the chain connected securely to the second eyebolt 218. The lower portion of the vertical side braces 230 and 232 are secured to the tree trunk 234 by a strap 226 that extends around the tree trunk 234 and is connected at opposite ends to respective eyebolts 222 and 228. A conventional ratcheting or tightening mechanism 227 on the strap 226 can be used to cinch the strap 226 tightly to the tree trunk 234.

The lower cross member 236 of the bracket assembly 200 has two receiver bracket members 202 and 204 on respective opposite ends 203, 205 to receive and fix the positions of the horizontal support members 126 and 128 of the seat assembly 102 (FIG. 2), as will be described in more detail below. An adjustable strut 346 slidably mounted in a sleeve 324 on the lower cross member 235 can be used to adjustably set the angle of the bracket assembly 200 in relation to the tree trunk 234 before the strap 226 is tightened. This feature is particularly useful with the ladder 348, as will be explained below. Essentially, the strut 346 holds the lower cross member a desired distance from the tree trunk 234, which can be set by inserting the pin 350 through any of the adjustment holes 347 in the strut 346, although any other convenient adjustment mechanism can also be used.

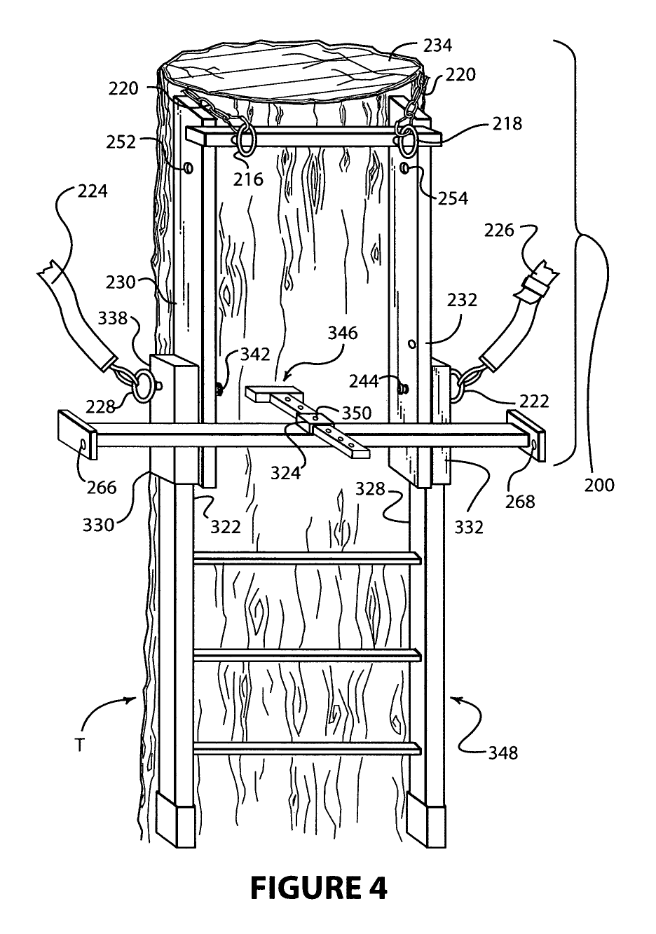

As shown in FIG. 4, the tree bracket 200 can be adopted for convenient connection to a ladder 348 with a pair of channel-shaped ladder receiver attachments 338, 340 affixed to the side braces 230, 232. The upper ends 322, 328 of the vertical risers of the ladder 348 (which can be any length in height and multiple sections) are inserted into the ladder receiver attachments 338 and 340 and can be retained there by the eye bolts 228, 222 or by any other convenient mechanism. The ladder receiver attachments 338 and 340 can be bolted in place using bolts 342 and 344 or fastened in any other convenient manner, such as welding, etc. Since the ladder 348 may be erected at an angle to the tree T, as illustrated in FIG. 1, the bracket assembly 200 has to be able to accommodate any such angle. Such accommodation can be made by setting the angle of the bracket assembly in relation to the tree T to match the angle of the ladder 348 to the tree T with the angle adjuster 346, as shown in FIG. 4, so that the upper ends 322, 328 of the ladder 348 do not bind in the ladder receiver attachments 338, 340. Alternatively, this angle accommodation can be made by swiveling or rotating the ladder receiver attachments 338, 340 in relation to the side braces 230, 232, or the lower ends 330, 332 of the ladder receiver attachments 338, 340 can be flared enough to accommodate more angles between the ladder 348 and the bracket assembly 200.

Also, with the ends 322, 328 of the ladder 348 inserted into the ladder receiver attachments 338, 340, as shown in FIG. 4, the ladder 348 can be used to raise the bracket assembly 200 to a desired height on the tree T. The user can then stand on the ladder 348 to mount the bracket assembly 200 on the tree T with the chain 220 and strap 224, as explained above.

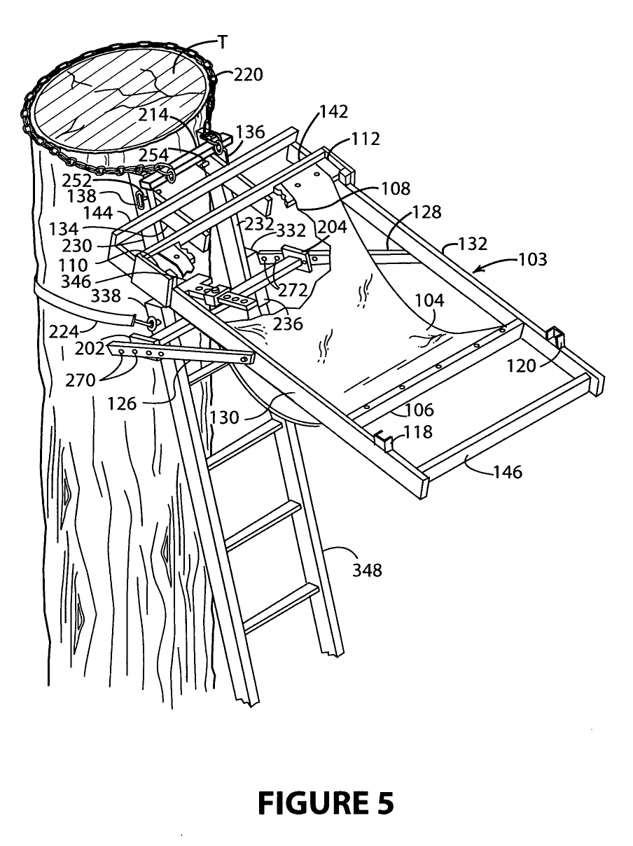

As mentioned above, the seat assembly 102 attaches to the bracket assembly 200, first by connecting the longitudinal support members 134, 136 to the side braces 230, 232, as shown in FIG. 5. This connection can be accomplished in any of a variety of ways, such as, for example, with the hitch pines 138, 140 inserted through the respective holes 252, 254 in the side braces 230, 232 and through the respective holes 152, 154 in the longitudinal support members 134, 136 as detailed in FIG. 2 and FIG. 3. The lower portion of the seat assembly 102 is then raised to a desired outstretched position and supported in that position by connecting the horizontal support members 126, 128 of the seat assembly 102 to the receiver bracket members 202, 204 of the bracket assembly 200 so that the distal or lower end of the seat assembly 102 cantilevers outwardly from the support members 126, 128. This connection can be made in any convenient manner, such as, for example, with bolts or pints 262, 264 inserted through respective holes 266, 268 in the receiver bracket members 202, 204 and through selected ones of the holes 270, 272 in the horizontal support members 126, 128. A plurality of holes 270, 272 are provided in the horizontal support members 126, 128 so that the angle between the seat assembly 102 and the bracket 200 is adjustable.

With the seat assembly 102 attached to the bracket assembly 200, as shown in FIG. 5, a person standing on the ladder 348 can open the space between the vertical support members 130, 132 by removing the cross member 108 from the upper pockets 110, 112 to move the sling seat 104 aside. Then the person can climb through that space to get above the seat assembly 102. Standing on the lower cross member 146, the user can extend the sling seat 104 back across the space between the vertical support members 130, 132 and replace the cross member 108 into the upper pockets 110, 112 to anchor the sling seat 104 into its use position for supporting the person in a sitting position. When the cross member 108 is removed from the pockets 110, 112 to move the sling seat 104 aside, as described above, the cross member 104 can be positioned temporarily in the lower pockets 118, 120. As explained above, this procedure is reversed for egress from the seat assembly 102.

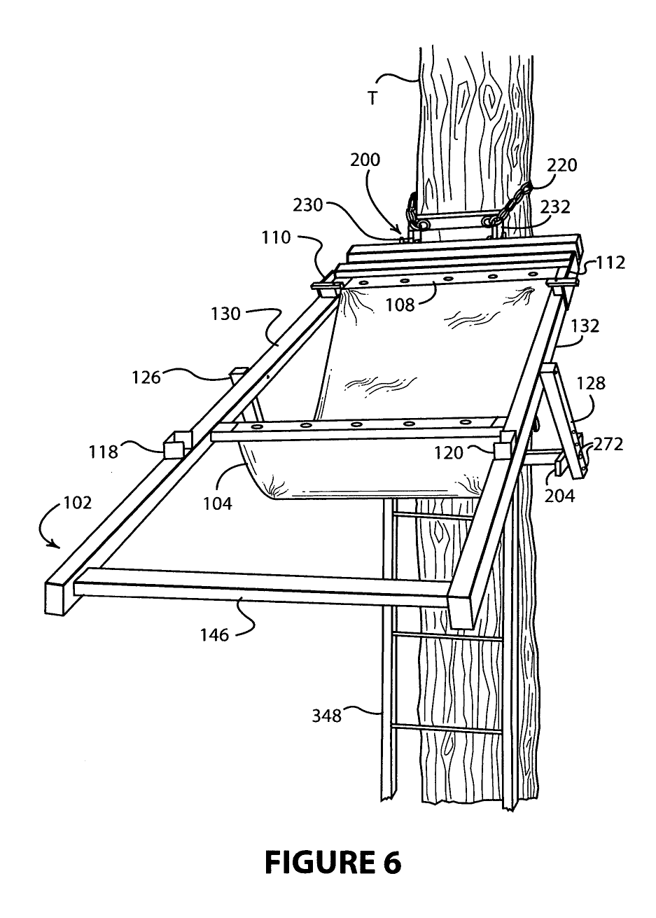

Of course, the sling seat 104 could also be made so that the bottom cross member 106 is moveable instead of, or in addition to, the moveable top cross member 108. Any other means of providing a seat structure between the vertical support members 130, 132 and that is moveable out of that space to allow ingress and egress of a user through that space can also be used for purposes of this invention. The seat assembly 102 attached to the bracket assembly 200 and mounted tree T with the sling seat 104 in position for use is shown in the perspective view of FIG. 6.

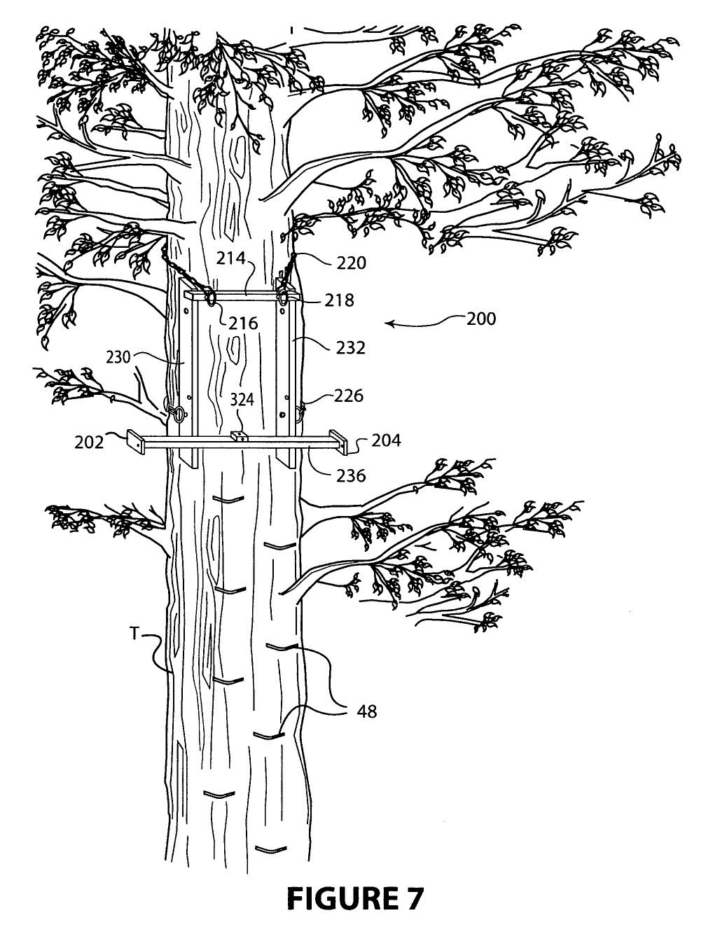

FIG. 7 illustrates the tree bracket 200 of the tree stand 100 installed onto the tree T and used in combination with screwed-on or strapped-on tree steps instead of the ladder described above. This illustration shows that the user may use any type of conventional tree steps in order to gain access to the tree stand 100, which can reduce the overall cost as well as eliminating the need to carry a long, heavy, and cumbersome ladder into the woods. Additionally, it gives greater versatility to the environment in which the device may be used. Sometimes specific tree structures are not conducive to stable erection of a ladder 348, such as when the tree trunk is excessively curved, there are obstructive branches, uneven ground conditions, or the like. In such instances, a user can selectively install tree steps 48 around branches and obstacles in order to reach the tree stand 100.

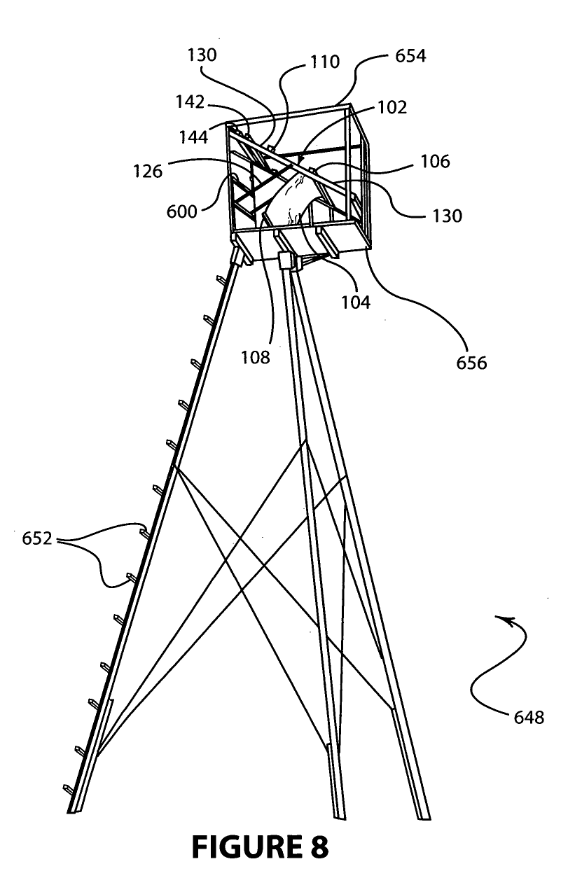

FIG. 8 illustrates an embodiment of the seat assembly 102 used in combination with a tripod mount 648 to act as a free standing elevated stand. As shown in FIG. 8, a conventional tripod type base 648 can be used in environments where trees are either not present or are not conducive to a tree mounted stand. A tripod 648 having a tripod platform 656 for a floor base is equipped with a set of tripod stairs 652 on at least one of the tripod legs used for gaining access to the elevated stand. In this embodiment, the bracket assembly 200, which is similar to the tree bracket assembly 200 described above, is mounted in the rear of the stand and supports the seat assembly 102 in a similar manner to the embodiments described above in relation to FIGS. 1 through 6. As detailed above, a rigid cross member 106 is rigidly fixed in place with vertical support members 130, 132 extending on either lateral side and forms the attachment point for the lower edge of the sling seat 104. The angle of the recliner assembly 102 is again held by horizontal support members 126, 128. The opposing upper edge of the sling seat 604 is fixed to the mobile cross member 108 that can be attached a variety of positions using frame pockets 110 to either adjust the fit of the sling seat 104 to the user, or to allow ingress and egress to the seat 104 of the stand through the center of the recliner assembly 102 in much the same way as described above. Support rails 654 may be added to the tripod design to form a railing around the seating area for added safety of the used, especially when used in a standing position or to steady a camera, bow, or rifle when shooting. Additional features may be added or adapted to the embodiments described above. For example, the bracket assembly 200 and/or the tripod platform 656 may be modified to incorporate a swing door section to aid in accessing the stand. This access as well as the mobile cross member 108 can have a locking means to place them in a secure and unusable manner when the stand is not in use.

Numerous advantages are realized in utilizing the disclosed embodiments which combine the features and advantages of a ladder stand, a fixed-position seat stand, a tripod stand, as well as a recliner-type sling seat, resulting in a versatile, comfortable stand, which is also much safer to use than most other currently available designs.

The foregoing description of the invention has been presented for purposes of illustration and description. It is not intended to be exhaustive or to limit the invention to the precise form or structure disclosed, and other modifications and variations may be possible in light of the above teachings and within the scope of the claims appended hereto. The embodiments described above were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art. The words “comprise,” “comprising,” “include,” “including,” and “includes” when used in this specification and in the following claims are intended to specify the presence of stated features, integers, components, or steps, but they do not preclude the presence or addition of one or more other features, integers, components, steps or groups thereof.

1. A viewing and hunting stand for attachment to a substantially rigid structure, to support a person in an elevated position comprising:
a detachable support including a frame for supporting said person;
an attachment bracket with connectors for fixedly attaching said bracket to said substantially rigid structure; and,
a receiver on said attachment bracket to removably attach said detachable support to said attachment bracket.

2. The viewing and hunting stand of claim 1, wherein said frame for supporting said person includes a sling of flexible material that is supported on opposing ends by a pair of rigid cross members supported by said frame thereby forming a recliner seat for said person.

3. The viewing and hunting stand of claim 2, wherein at least one of said rigid cross members is releasably attached to said frame of said detachable support.

4. The viewing and hunting stand of claim 3, wherein said frame includes a first frame pocket and a second frame pocket located on said frame such that when the ends of the rigid cross members are inserted in said first and second frame pockets, said recliner seat forms a sling-type seat.

5. The viewing and hunting stand of claim 2, wherein said person gains access, from a non-elevated position to said detachable support in said elevated position, by passing through said frame and between attachment points of said pair of rigid cross members that support said opposing ends of said recliner seat.

6. The viewing and hunting stand of claim 1, wherein said substantially rigid structure is a tree.

7. The viewing and hunting stand of claim 1, wherein said substantially rigid structure is a freestanding tripod.

8. The attachment bracket of claim 1, further comprising:
one or more ladder receiver attachments that facilitate connection with an upper portion of a ladder that used to gain access to said viewing and hunting stand.

9. The attachment bracket of claim 1, further comprising:
an angle adjustment member that is placed between said substantially rigid structure and a lower portion of said attachment bracket to produce an inclination of said ladder with respect to said substantially rigid structure.

10. A viewing and hunting stand for attachment to a substantially rigid structure, to support a person in an elevated position comprising:
a detachable seat assembly comprising:
a frame for supporting said person;
a sling of flexible material that is supported on opposing ends by a pair of rigid cross members that are laterally supported by said frame thereby forming a seat for said person;
a bracket assembly comprising:
at least one connector for fixedly attaching said bracket assembly to said substantially rigid structure;
a receiver for releasably attaching an upper portion of said detachable seat assembly to said recliner bracket such that said detachable recliner assembly will pivot at said point of said receiver while supporting the weight of said detachable seat assembly and said person; and,
a horizontal support member that connects said bracket assembly, below said point of said receiver to said detachable seat assembly thereby supporting a lower portion of said detachable seat assembly away from said bracket assembly at an angle.

11. The viewing and hunting stand of claim 10, wherein at least one of said rigid cross members is releasably attached to said frame of said detachable support.

12. The viewing and hunting stand of claim 11, wherein said frame includes a first frame pocket and a second frame pocket located on said frame such that when the ends of the rigid cross members are inserted in said first and second frame pockets, said seat forms a sling-type seat.

13. The viewing and hunting stand of claim 10, wherein said person gains access, from a non-elevated position to said detachable support in said elevated position, by passing through said frame and between attachment points of said pair of rigid cross members that support said opposing ends of said seat.

14. The viewing and hunting stand of claim 10, wherein said substantially rigid structure is a trunk of a tree.

15. The viewing and hunting stand of claim 10, wherein said substantially rigid structure is a freestanding tripod.

16. The recliner bracket of claim 10, further comprising:
one or more ladder receiver attachments that facilitate connection with an upper portion of a ladder that used to gain access to said viewing and hunting stand.

17. The recliner bracket of claim 16, further comprising:
an angle adjustment member that is placed between said substantially rigid structure and a lower portion of said attachment bracket to produce an inclination of said ladder with respect to said substantially rigid structure.

18. The viewing and hunting stand of claim 10, wherein said recliner bracket is foldable.

19. A system for creating an elevated viewing and hunting stand comprising the steps of:
attaching one or more or attachment brackets to one or more rigid structures which are at various desired locations;
selecting one of said previously affixed attachment brackets that is fixedly attached to said rigid structure;
attaching a detachable support including a frame for supporting said person to said selected attachment bracket.

20. A method for creating an elevated viewing and hunting stand comprising the steps of:
attaching a bracket assembly to a substantially rigid structure, said bracket assembly having a receiver for releasably attaching an upper portion of a detachable seat assembly to said bracket assembly such that said detachable seat assembly will pivot at said point of said receiver while supporting the weight of said detachable seat assembly and said person, a horizontal support member that connects said bracket assembly, below said point of said receiver to said detachable seat assembly thereby supporting a lower portion of said detachable seat assembly away from said bracket assembly at an angle;
attaching said detachable seat assembly having a frame for supporting said person, a sling of flexible material that is supported on opposing ends by a pair of rigid cross members that are laterally supported by said frame thereby forming a seat for said person to said bracket assembly.

21. The method of claim 20, wherein at least one of said rigid cross members is releasably attached to said frame of said detachable support.

22. The method of claim 20, further comprising the steps of:
determining that at least one of said rigid cross members is not engaged with said frame;
climbing up through said frame and between attachment points of said pair of rigid cross members that support said opposing ends of said seat;
engaging the ends of said rigid cross members that is not engaged with said frame; and,
sitting down in said seat.

23. The method of claim 20, wherein said frame includes a first frame pocket and a second frame pocket located on said frame such that when the ends of said rigid cross members are inserted in said first and second frame pockets, said recliner seat forms a sling-type seat.

24. The method of claim 20, wherein said substantially rigid structure is a tree.

25. The viewing and hunting stand of claim 20, wherein said a substantially rigid structure is a freestanding tripod.

26. Platform apparatus for supporting a person above the ground, including a frame adapted for attachment to substantially rigid structure and a detachable support connected to and supported by said frame in a use position for supporting said person in a seat space above the ground comprising:
means for allowing said seat to be moved with respect to said frame enough for said person to pass through at least a portion of said seat space.

27. The platform apparatus of claim 26, wherein said seat is comprised of a sling of flexible material that is supported on opposing ends by a pair of rigid cross members supported by said frame.

28. The platform apparatus of claim 27, including means for releasably attaching at least a portion of said sling of flexible material to said frame.

29. The platform apparatus of claim 28, wherein said sling of flexible material is attached at one edge to a moveable member, which itself is releasably attachable to said frame.

30. The platform apparatus of claim 29, including means for releasably attaching said moveable member to said frame.

31. The platform apparatus of claim 30, wherein another portion of sling of flexible material is nonreleasably attached to said frame.

32. The platform apparatus of claim 26, further comprising:
an attachment bracket with means for mounting said attachment bracket on a tree; and,
means for releasably attaching said frame to said attachment bracket.

33. The platform apparatus of claim 32, including means for releasably attaching a ladder to said attachment bracket below said frame.

34. The platform apparatus of claim 32, including angle adjustment means for adjustably setting and maintaining a desired angle of said attachment bracket with respect to said tree.

35. The platform apparatus of claim 32, including adjustable brace means for adjustably setting and maintaining a desired angular position of said frame with respect to said attachment bracket.

36. The platform apparatus of claim 26, further comprising:
attachment bracket with means for mounting said attachment bracket on a freestanding tripod; and
means for releasably attaching said frame to said attachment bracket.

37. A viewing and hunting stand for attachment to a substantially rigid structure, to support a person in an elevated position comprising:
a frame for supporting said person;
a sling of flexible material that is supported on opposing ends by a pair of rigid cross members that are laterally supported by said frame thereby forming a recliner seat for said person, said sling that can be repositioned such that an opening suitable for a person to pass through is created within said frame;
at least one connector for fixedly attaching said recliner assembly to said substantially rigid structure.

38. The viewing and hunting stand of claim 37, wherein at least one of said rigid cross members is releasably attached to said frame of said detachable support.

39. The viewing and hunting stand of claim 37, wherein said frame includes a first frame pocket and a second frame pocket located on said frame such that when the ends of the rigid cross members are inserted in said first and second frame pockets, said recliner seat forms a sling-type seat.

40. The viewing and hunting stand of claim 37, wherein said substantially rigid structure is a trunk of a tree.

41. The viewing and hunting stand of claim 37, wherein said substantially rigid structure is a freestanding tripod.

42. The viewing and hunting stand of claim 37, further comprising:
one or more ladder receiver attachments that facilitate connection with an upper portion of a ladder that used to gain access to said viewing and hunting stand.

43. The viewing and hunting stand of claim 37, further comprising:
an angle adjustment member that is placed between said substantially rigid structure and said frame to produce an inclination of said ladder with respect to said substantially rigid structure.

44. A method for creating an elevated viewing and hunting stand comprising the steps of:
attaching a frame for supporting a person to a substantially rigid structure, said frame having a sling of flexible material that is supported on opposing ends by a pair of rigid cross members that are laterally supported by said frame thereby forming a recliner seat for said person,
accessing said sling of flexible material by repositioning said sling of flexible material such that an opening suitable for a person to pass through is created within said frame;
passing through said opening;
returning said sling of flexible material to its original position as said recliner seat;
sitting in said recliner seat.

45. The method of claim 44, wherein at least one of said rigid cross members is releasably attached to said frame of said detachable support.

46. Stand apparatus for supporting a person above the ground, comprising:
a frame surrounding a space, said frame being adapted for mounting above the ground; and
a removable seat positioned in said space and releaseably connected to said frame in a manner that allows a seat to be disconnected from the frame and moved aside so that a person can climb through the space.

47. The stand apparatus of claim 46, with in the seat comprises a flexible material, at least a portion of which is releaseably connect to the frame.
